(19) United States
(12) Patent Application Publication
(10) Pub. No.: US 2026/0311484 A1
(43) Pub. Date: Oct. 8, 2026

(54) Computer Vision Systems and Methods for Detecting Property Barriers and Enclosed Elements from Imagery

(71) Applicant: Insurance Services Office, Inc., Jersey City, NJ (US)

(72) Inventors: Miguel López Gavilán, Alcorcón (ES); Francisco Miguel Rivas Montero, Móstoles (ES); Jose David Aguilera Martin de los Santos, Matthews, NC (US); Antonio Godino Cobo, South Jordan, UT (US)

(73) Assignee: Insurance Services Office, Inc., Jersey City, NJ (US)

(21) Appl. No.: 19/170,970

(22) Filed: Apr. 4, 2025

Related U.S. Application Data
(60) Provisional application No. 63/569,896, filed on Mar. 26, 2024.

(51) Int. Cl. G06V 20/10; G06V 10/26; G06V 10/44; G06V 10/764; G06V 10/82

(52) U.S. Cl. CPC G06V 20/176; G06V 10/26; G06V 10/44; G06V 10/764; G06V 10/82

(57) ABSTRACT

Computer vision systems and methods for detecting property barriers and enclosed elements from imagery are provided. The system receives a digital image of a property and processes the digital image to identify locations or elements of interest in the image and to detect one or more barriers present in the image. The system processes the detected barriers to estimate one or more enclosed regions, and then processes the locations/elements of interest and the estimated enclosed regions to estimate whether the locations/elements are enclosed by the one or more enclosed regions.

### RELATED APPLICATIONS

This application claims priority to U.S. Provisional Patent Application Ser. No. 63/569,896 filed on Mar. 26, 2024, the entire disclosure of which is hereby expressly incorporated by reference

### BACKGROUND

### Technical Field

The present disclosure relates generally to the field of computer vision. More specifically, the present disclosure relates to computer vision systems and methods for detecting property barriers and enclosed elements from imagery.

### Related Art

In the insurance underwriting fields, the ability to detect whether property elements are safely enclosed by a barrier (e.g., a fence or some other barrier) is of significant importance. For example, knowing whether a property element such as a pool or a trampoline is enclosed by a barrier is an important factor from the insurance underwriting perspective because it can impact the risk associated with the property. Enclosed elements may prevent or minimize the risk of accidents, injuries, and/or unauthorized access, thereby reducing the likelihood of liability claims related to such incidents. Therefore, identifying the property elements that pose such risks and assessing their enclosure status helps underwriters make more informed decisions about the property risk profile and the appropriate insurance coverage.

Computer vision and artificial intelligence technologies are increasingly being used in the insurance underwriting and claims processing fields. Such technologies have the ability to detect various features in input data sources, such as digital images, textual data, etc. However, to date, such technologies have not adequately been leveraged to detect property barriers and enclosed element from a wide variety of imagery.

Accordingly, what would be desirable, but have not yet been provided, are computer vision systems and methods for detecting property barriers and enclosed elements from imagery which address the foregoing, and other, needs.

### SUMMARY

The present disclosure relates to computer vision systems and methods for detecting property barriers and enclosed elements from imagery. The system receives a digital image of a property and processes the digital image to identify locations or elements of interest in the image and to detect one or more barriers present in the image. The system processes the detected barriers to estimate one or more enclosed regions, and then processes the locations/elements of interest and the estimated enclosed regions to estimate whether the locations/elements are enclosed by the one or more enclosed regions.

### BRIEF DESCRIPTION OF THE DRAWINGS

The foregoing features of the invention will be apparent from the following Detailed Description of the Invention, taken in connection with the accompanying drawings, in which:

FIG. 1 is a flowchart illustrating processing steps in accordance with the systems and methods of the present disclosure;

FIG. 2 is an aerial image processed by the systems and methods of the present disclosure, wherein elements of interest are specified as points;

FIGS. 3-4 are flowcharts illustrating step 16 of FIG. 1 in greater detail;

FIG. 5 is a flowchart illustrating step 18 of FIG. 1 in greater detail;

FIG. 6 illustrates barrier segmentation and corresponding enclosed area estimation performed by the systems and methods of the present disclosure;

FIG. 7 is a flowchart illustrating step 20 of FIG. 1 in greater detail;

FIG. 8 illustrates identification by the system of enclosed locations of interest;

FIG. 9 illustrate identification by the system of an unenclosed item on a property;

FIG. 10 illustrates enclosed area estimation performed by the system with classified sections and barrier segmentation; and

FIG. 11 is a diagram illustrating sample hardware components capable of being utilized to implement the systems and methods of the present disclosure.

### DETAILED DESCRIPTION

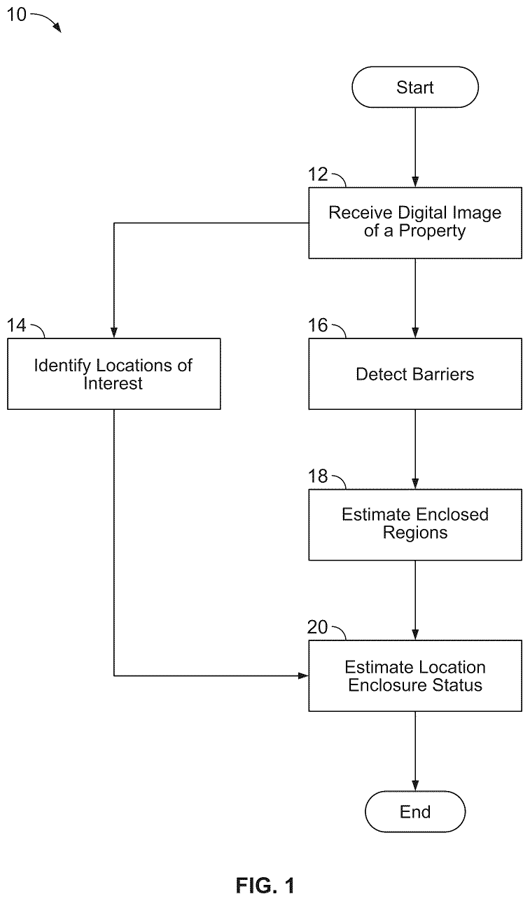

The present disclosure relates to computer vision systems and methods for detecting property barriers and enclosed elements from imagery, as discussed in detail below in connection with FIGS. 1-11.

FIG. 1 is a flowchart illustrating processing steps in accordance with the systems and methods of the present disclosure, indicated generally at 10. Beginning in step 12, the system receives a digital image of a property. The digital image could be of any suitable type of image, including, but not limited to, an aerial image, satellite image, light detection and ranging (LiDAR) image, or other suitable type of image. Next, in step 14, the system processes the digital image to identify locations of interest in the image. The elements of interest may be any number of property elements, locations, or objects, such as pools, trampolines, or other elements whose enclosure status (e.g., a determination of whether the element/location/object is enclosed by a fence or other structure) is required. These elements are not limited to specific objects within the property, and the system can operate on any location within the property or its surroundings. These elements or locations of interest can be either pre-defined by a user, indicated by stakeholders or customers, or detected using an AI model. Further, the elements/locations may be indicated as points, boxes or contours referred to using image coordinates or geospatial coordinates, which can be projected to the image coordinates. Target locations may be also defined by a segmentation mask that enables identifying the pixels belonging to each location of interest.

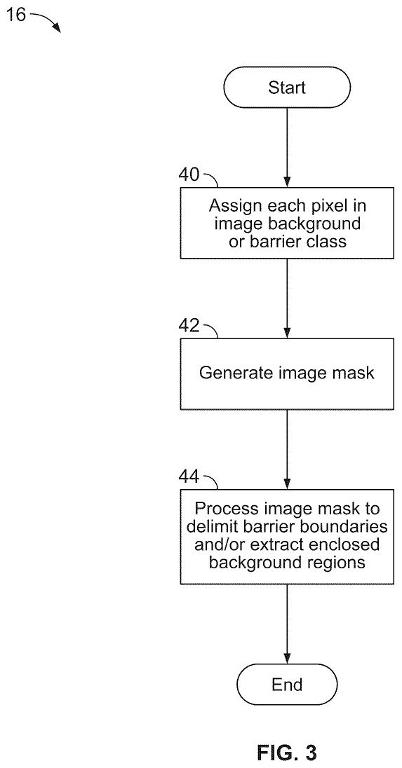

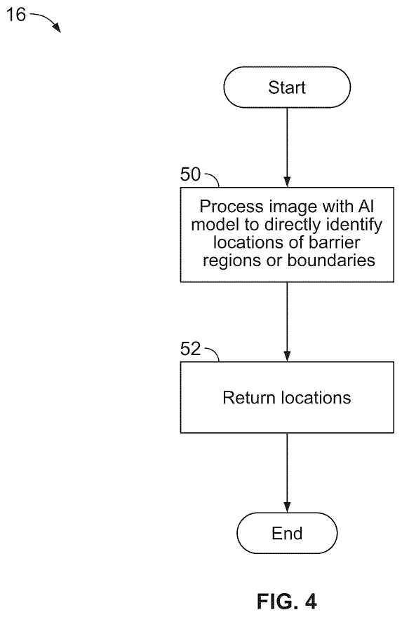

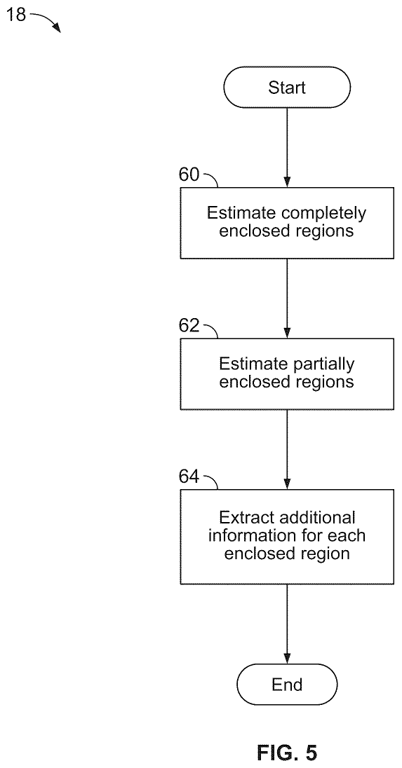

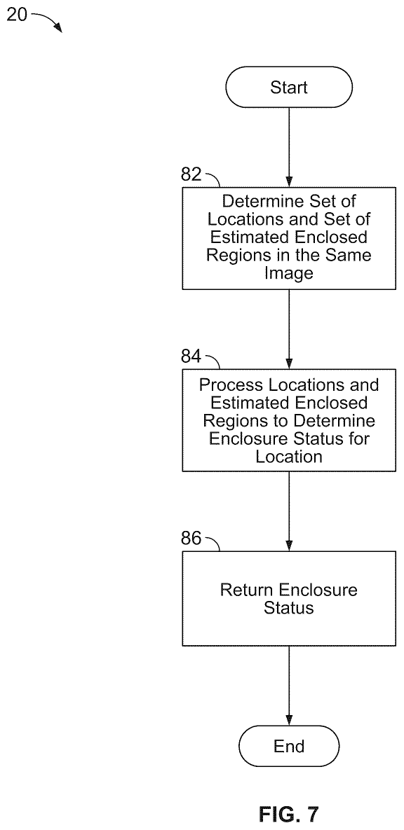

In step 16, discussed in greater detail below in connection with FIG. 3, the system detects one or more barriers in the digital image. Then, in step 8 (discussed in greater detail below in connection with FIGS. 4-5), the system estimates one or more enclosed regions in the image using the one or more barriers detected in step 16. Finally, in step 20 (discussed in greater detail below in connection with FIG. 7), the system estimates the enclose status for the location/element/object using the location(s) of interest identified in step 14 and the enclosed regions estimated in step 18.

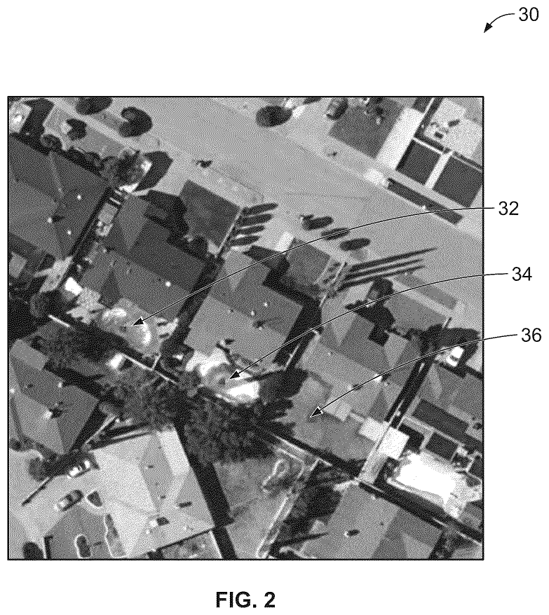

FIG. 2 is an aerial image processed by the systems and methods of the present disclosure, wherein elements of interest are specified as points 32-36 in the image 30. As can be seen, points 32-34 correspond to pools on the two depicted properties, and point 36 corresponds to a backyard of the third depicted property. Importantly, a wide variety of elements can be specified, including, but not limited to, pools, trampolines, play structures, above-ground tanks, backyards, towers, or any other elements of interest.

FIG. 3 is a flowchart illustrating step 16 of FIG. 1 in greater detail. The system can detect all barriers of interest contained in the input image. These barriers may include any kind of fencing and/or vegetation surrounding the property or portions of the property parcel, the building walls, or any other artificial or natural barrier of any kind that prevents passing through the property. Barriers can be detected using a barrier segmentation technique illustrated in FIG. 3, and/or using a barrier boundary technique illustrated in FIG. 4, discussed below. More specifically, in the barrier segmentation technique, in step 40, the system assigns each pixel in the image a background or a barrier class using a semantic segmentation artificial intelligence (AI) model. This model may consist of a convolutional or a transformer-based neural network, among other architectures. Through iterative training on annotated datasets, the neural network model optimizes its parameters to capture local and global context information or features given an input image and provide an accurate pixel-level classification for the target classes. Then, in step 42, the system generates an image mask that can be further processed to delimit the barrier boundaries and/or to extract enclosed background regions. Then, in step 44, the system processes the image mask to delimit barrier boundaries and/or to extract enclosed background regions (e.g., background areas isolated from other background areas as a result of being surrounded by barriers).

FIG. 4 is a flowchart illustrating the barrier boundary technique capable of being performed in step 16 (in place of, or in addition to, the steps discussed in connection with FIG. 3). In step 50, the system processes the image using an AI model to directly identify locations of barrier regions or boundaries, and then in step 52, returns the identified locations of barrier regions or boundaries. This AI model may consist of a neural network trained following a data driven approach for detection or instance segmentation task. In this case, the neural network may estimate the image coordinates for the objects of interest in the form of bounding boxes, centroid point location, object segmentation mask or directly estimate the contour points delimiting the boundaries of each object in the image. The AI model can return many building footprints, parcel boundaries, fencing lines, vegetation contours, etc., which can be combined by the system to estimate the barrier boundaries within the property.

FIG. 5 is a flowchart illustrating step 18 of FIG. 1 in greater detail. In step 60, the system estimates completely enclosed regions using the results of the barrier detection discussed above in connection with FIGS. 3-4. The completely enclosed regions can be estimated by identifying background regions that are fully isolated from any other background regions as a result of being surrounded by barrier boundaries. For barriers estimated through an image segmentation mask, the completely enclosed areas can be extracted by finding the background blobs (connected background pixels) within the image mask that do not overlap the image limits or the limits of the parcel of interest within the image. For barrier boundaries estimated using a detection approach, the barrier boundaries can be combined using a union operation, and the completely enclosed regions can then be extracted by finding the closed components between boundaries that do not overlap the image limits or the limits of the parcel of interest within the image.

In step 62, the system estimates partially enclosed regions using the results of the barrier detection discussed above in connection with FIGS. 3-4. Partially enclosed regions can be estimated by identifying background regions that would be isolated from any other background region if the barrier boundaries are expanded up to a certain gap length tolerance. For barriers estimated through an image segmentation mask, partially enclosed areas can be extracted by applying a dilation operation on the barrier segmentation mask up to a certain maximum gap tolerance and then finding the isolated background blobs. For barrier boundaries estimated using a detection approach, partially enclosed areas can be extracted by applying a buffering operation on each barrier boundary elements up to a certain maximum gap tolerance and then finding the closed components.

In step 64, the system extracts additional information for each enclosed region. Such regions can be directly segmented or detected using an AI model, without depending on barrier pre-estimation. For each enclosed region, additional information may be extracted such as, but not limited to, perimeter, area, maximum gap length (for partially enclosed regions), barrier type lengths and length percentages, and the sections that conform the enclosed region boundary, separated by barrier type. Barrier type statistics and sections can be determined for example by classifying each point in the enclosed region contour. This may be done by assigning to each of those points the class of the closest point or pixel given the barrier boundary points or the barrier segmentation mask, up to a certain margin.

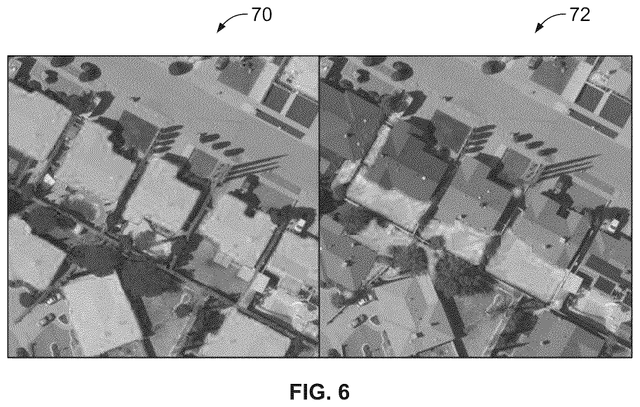

FIG. 6 illustrates barrier segmentation and corresponding enclosed area estimation performed by the systems and methods of the present disclosure. The image 70 illustrates barrier segmentation being performed by the system, wherein the barriers are highlighted, and the image 72 illustrates the corresponding enclosed areas estimated by the system (highlighted in the image 72).

FIG. 7 is a flowchart illustrating step 20 of FIG. 1 in greater detail. In step 82, the system determines a set of locations or element locations in any format within the image (points, boxes, contours, masks, etc.) and a set of estimated enclosed regions in the same image. Then, in step 84, the system processes the locations and estimated enclosed regions to determine the enclosure status for the location. A location or element is estimated as closed if it completely falls within an enclosed region or if it has a sufficient overlap with the enclosed region. This criterion may change depending on specific needs or depending on the type of the element. Finally, ins tep 86, the system returns the enclosure status.

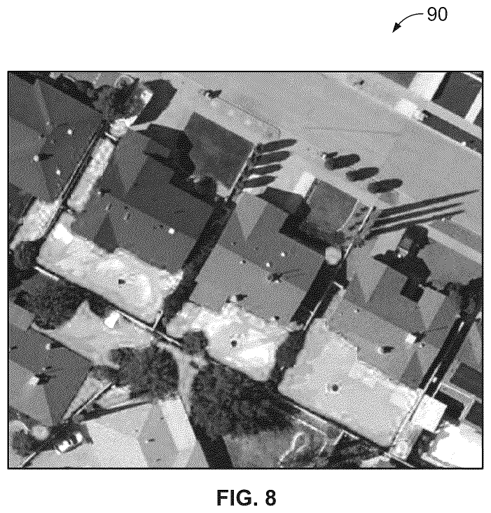

FIG. 8 is an image 90 illustrating identification by the system of enclosed locations of interest. The points in the image correspond to the points 32-34 of FIG. 2 (identifying pools on the two depicted properties) and point 36 of FIG. 2 (identifying a backyard of the third depicted property). The shaded regions in the image 90 illustrate the enclosed regions identified by the system. Since each of the points are determined by the system to be enclosed by corresponding regions, the system estimates the objects corresponding to the points (here, the two pools and the backyard) as being enclosed as they are located within enclosed regions.

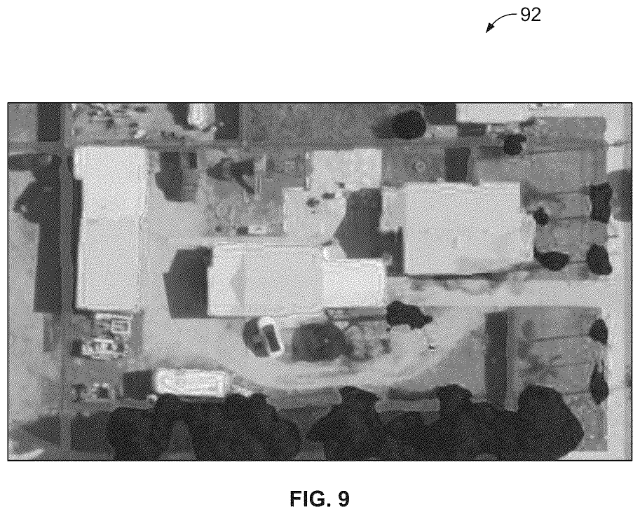

FIG. 9 is an image 92 illustrating identification by the system of an unenclosed item on a property. Here, the item of interest is a trampoline (indicated by the dot toward the center of the image), and since the barriers indicated by the shading in the image (detected by the system) have gaps between the barriers that are too large to be considered a closed region around the trampoline, the trampoline is estimated by the system as not being enclosed.

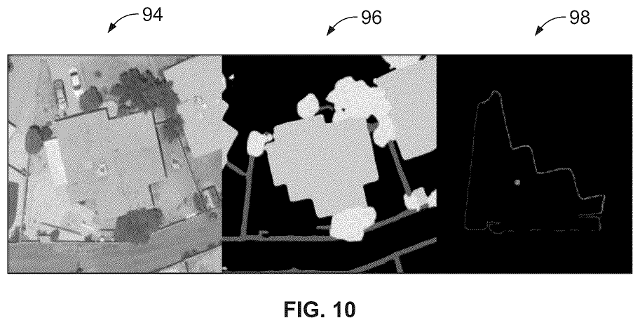

FIG. 10 illustrates enclosed area estimation performed by the system with classified sections and barrier segmentation. Image 94 is the input image, image 96 illustrates classified sections within the image (different shading corresponding to different classes of detected objects, e.g., buildings, vegetation, etc.), and image 98 illustrates barrier segmentation performed by the system. As can be seen in the image 98, the segmentation corresponds to an enclosed side yard detected from the input image 94, which the system identifies as an enclosed region.

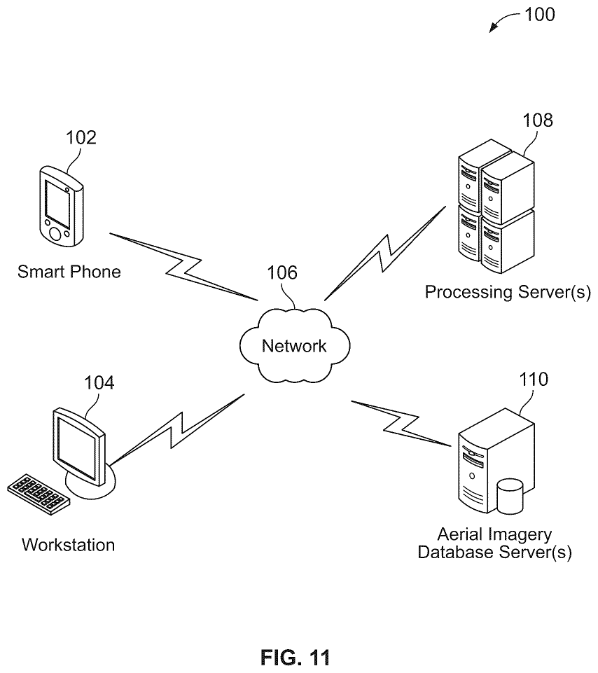

FIG. 11 is a diagram illustrating sample hardware components capable of being utilized to implement the systems and methods of the present disclosure. The various processing steps disclosed herein could be embodied as computer-readable code written in any suitable high-or low-level programming language (including, but not limited to, C, C++, C#, Java, Python, or other suitable programming language) stored in a non-transitory computer-readable memory (including, but not limited to, disk, random-access memory, read-only memory, flash memory, etc.) and executable by one or more computer processors/computing systems. Examples of such computing systems include, but are not limited to, a smart telephone 102, a workstation 104, and/or a processing server 108 (which could be a standalone server, cluster of servers, a cloud computing platform, etc.). That is, the computer-readable code could be executed by one or more of these devices, each of which could be in communication with the others via a communications network 106 (local area network, wide area network, Internet, cellular data network, etc.). Additionally, the systems 102-108 could obtain the digital images discussed herein from an aerial imagery database server 110, which could also be in communication with the systems 102-108 via the network 106. Additionally, it is noted that systems and methods disclosed herein could be implemented using one or more customized hardware components, such as a field-programmable gate array (FPGA), application-specific integrated circuit (ASIC), or other hardware component.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A computer vision system for detecting property barriers and enclosed elements from imagery, comprising:
a processor in communication with an aerial imagery database, the processor programmed to:
receive a digital image of a property;
process the digital image to identify a location of interest in the image;
process the digital image to detect one or more barriers in the image;
estimate one or more enclosed regions in the image using the one or more barriers detected in the image; and
estimate an enclosure status for the location of interest.

2. The system of claim 1, wherein the processor detects the one or more barriers in the image by assigning each pixel in the image a background or a barrier class using a semantic segmentation artificial intelligence (AI) model.

3. The system of claim 2, wherein the AI model comprises a convolutional or a transformer-based neural network.

4. The system of claim 3, wherein the neural network includes optimized parameters for capturing local and global context information.

5. The system of claim 2, wherein the processor detects the one or more barriers in the image by generating an image mask and processing the image mask to delimit barriers or extract enclosed background regions.

6. The system of claim 5, wherein the processor detects the one or more barriers in the image by processing the image mask to delimit the barrier boundaries or to extract the enclosed background regions.

7. The system of claim 1, wherein the processor detects the one or more barriers in the image by processing the image using an artificial intelligence (AI) model to directly identify locations of barrier regions or boundaries.

8. The system of claim 7, wherein the processor detects the one or more barriers in the image by returning identified locations of the barrier regions or the boundaries.

9. The system of claim 7, wherein the AI model comprises a neural network that estimates image coordinates for objects of interest using one or more of a bounding box, a centroid point location, an object segmentation mask, or a direct estimate of contour points delimiting the boundaries of each object in the image.

10. The system of claim 1, wherein the processor estimates the one or more enclosed regions by estimating completely enclosed regions.

11. The system of claim 10, wherein the processor estimates the one or more enclosed regions by estimating partially enclosed regions.

12. The system of claim 11, wherein the processor extracts information from the one or more enclosed regions including one or more of perimeter, area, maximum gap length, barrier type lengths, length percentages, or sections conforming to the enclosed region boundary.

13. A computer vision method for detecting property barriers and enclosed elements from imagery, comprising:
receiving a digital image of a property;
processing the digital image to identify a location of interest in the image;
processing the digital image to detect one or more barriers in the image;
estimating the one or more enclosed regions in the image using the one or more barriers detected in the image; and
estimating an enclosure status for the location of interest.

14. The method of claim 13, further comprising detecting the one or more barriers in the image by assigning each pixel in the image a background or a barrier class using a semantic segmentation artificial intelligence (AI) model.

15. The method of claim 14, wherein the AI model comprises a convolutional or a transformer-based neural network.

16. The method of claim 15, wherein the neural network includes optimized parameters for capturing local and global context information.

17. The method of claim 13, further comprising detecting the one or more barriers in the image by generating an image mask and processing the image mask to delimit barriers or extract enclosed background regions.

18. The method of claim 17, further comprising detecting the one or more barriers in the image by processing the image mask to delimit the barrier boundaries or to extract the enclosed background regions.

19. The method of claim 13, further comprising detecting the one or more barriers in the image by processing the image using an artificial intelligence (AI) model to directly identify locations of barrier regions or boundaries.

20. The method of claim 19, further comprising detecting the one or more barriers in the image by returning identified locations of the barrier regions or the boundaries.

21. The method of claim 19, wherein the AI model comprises a neural network that estimates image coordinates for objects of interest using one or more of a bounding box, a centroid point location, an object segmentation mask, or a direct estimate of contour points delimiting the boundaries of each object in the image.

22. The method of claim 13, further comprising estimating the one or more enclosed regions by estimating completely enclosed regions.

23. The method of claim 22, further comprising estimating the one or more enclosed regions by estimating partially enclosed regions.

24. The method of claim 23, further comprising extracting information from the one or more enclosed regions including one or more of perimeter, area, maximum gap length, barrier type lengths, length percentages, or sections conforming to the enclosed region boundary.
